(19) United States
(12) Patent Application Publication
(10) Pub. No.: US 2024/0069303 A1
(43) Pub. Date: Feb. 29, 2024

(54) OPTICAL FOCUS ADJUSTMENT MODULE AND HEAD MOUNTED ELECTRONIC DEVICE

(71) Applicant: NEWMAX TECHNOLOGY CO., LTD., Taichung City (TW)

(72) Inventor: Ming-Huang HUANG, Taichung City (TW)

(21) Appl. No.: 17/982,044

(22) Filed: Nov. 7, 2022

(30) Foreign Application Priority Data
Aug. 29, 2022 (TW) 111132469

(51) Int. Cl. G02B 7/04; G02B 25/00; G06F 1/16

(52) U.S. Cl. CPC G02B 7/04; G02B 25/001; G06F 1/163

(57) ABSTRACT

An optical focus adjustment module includes an operating ring; a first lens barrel disposed in the operating ring and including three grooves; a second lens barrel disposed in the first lens barrel and including one first protrusion portion and two second protrusion portions, wherein the first protrusion portion and the two second protrusion portions are disposed in the three grooves respectively and adapted to move parallel to a central axis; first and second optical lens assemblies disposed in the first and second lens barrels respectively; a gear disposed in the operating ring and meshed with an inner surface of the operating ring; and a screw rod disposed in a through hole of the first protrusion portion and rotationally synchronized with the gear and the operating ring, whereby the operating ring drives the second lens barrel, and then moves the second optical lens assembly to a predetermined position.

This application claims the benefit of Taiwan Patent Application No. 111132469, filed on Aug. 29, 2022, which is hereby incorporated by reference for all purposes as if fully set forth herein.

### BACKGROUND

### Technical Field

The present disclosure relates to an optical focus adjustment module, in particular to a head mounted electronic device having an optical focus adjustment module.

### Related Art

Virtual Reality (VR) is a computer simulation system capable of creating and experiencing a virtual world and utilizing a computer for generating an interactive analogous environment of the multi-source information fusion to make users immersed in the interactive environment. With constant development of the technology, VR is increasingly applied to industries and fields such as medicine, entertainment, industrial simulation, aerospace and education.

A Head Mounted Device (HMD) serving as one of important devices for realizing VR is gradually popularized in life. The HMD can expand a scientific three-dimensional visualization degree, promotes the interaction performance between a user and a computer, and is increasingly focused by people along with application of VR in many technical fields.

Currently, a head mounted electronic device is used in a glasses-wearing mode or a naked-eye mode, and thus a space for accommodating glasses may be reserved during designing the head mounted electronic device. However, if a myopic user wears glasses and then uses the head mounted electronic device, it is possible to compress the glasses of the user, and consequently discomfort or glasses damage is caused. If the myopic user selects to directly use the head mounted electronic device without wearing the glasses, the user cannot clearly see images or feels uncomfortable due to focal length, and consequently resists the head mounted electronic device.

Thus, the optical focus adjustment module and the head mounted electronic device need to be provided for solving previous problems.

### SUMMARY

An objective of the present disclosure is to provide the optical focus adjustment module to achieve a myopia adjustment effect by adjusting image positions.

To achieve the above objective, the present disclosure provides an optical focus adjustment module having a central axis, an eye side and an image source side, the optical focus adjustment module comprising: an operating ring comprising an inner surface; a first lens barrel disposed in the operating ring and comprising three grooves parallel to the central axis; a first optical lens assembly disposed in the first lens barrel; a second lens barrel disposed in the first lens barrel and comprising one first protrusion portion and two second protrusion portions, wherein: the first protrusion portion comprises a through hole having an internally threaded structure, and the first protrusion portion is disposed in one of the three grooves and adapted to move parallel to the central axis; and the two second protrusion portions are disposed in the other two of the three grooves and adapted to move parallel to the central axis; a second optical lens assembly disposed in the second lens barrel; a gear disposed in the operating ring and meshed with the inner surface of the operating ring; and a screw rod disposed in the through hole and comprising a threaded structure, wherein the threaded structure and the internally threaded structure are physically connected to each other, and the screw rod is rotationally synchronized with the gear and the operating ring.

The present disclosure further provides a head mounted electronic device, comprising: a shell; at least one optical focus adjustment module of the present disclosure disposed in the shell; and a controller disposed in the shell.

According to the optical focus adjustment module of the present disclosure, it utilizes the interaction between the through hole of the first protrusion portion of the second lens barrel and the screw rod, and thus the distance between the second optical lens of the second optical lens assembly and the image source can be adjusted only by rotating the operating ring to drive the screw rod to move, thereby achieving a myopia adjustment effect by adjusting image positions.

### BRIEF DESCRIPTION OF THE DRAWINGS

FIG. 1 is a combined three-dimensional schematic view of an optical focus adjustment module according to an embodiment of the present disclosure.

FIG. 2 is an exploded three-dimensional schematic view of an optical focus adjustment module according to an embodiment of the present disclosure.

FIG. 3 is a first combined sectional schematic view of an optical focus adjustment module according to an embodiment of the present disclosure, showing that a second optical lens assembly in a second lens barrel is moved from a first predetermined position to a second predetermined position.

FIG. 4 is a combined sectional schematic view of a first lens barrel, a second lens barrel and a second optical lens assembly of an optical focus adjustment module according to an embodiment of the present disclosure.

FIG. 5 is a second combined sectional schematic view of an optical focus adjustment module according to an embodiment of the present disclosure.

FIG. 6 is a plan view of a scale cover of an optical focus adjustment module according to an embodiment of the present disclosure.

FIG. 7 is a three-dimensional schematic view of a head mounted electronic device according to an embodiment of the present disclosure.

### DETAILED DESCRIPTION

To make the foregoing objectives, characteristics and features of the present disclosure more comprehensible, preferred embodiments of the present disclosure are described in detail below with reference to the accompanying drawings.

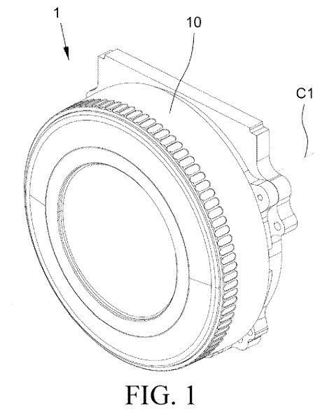

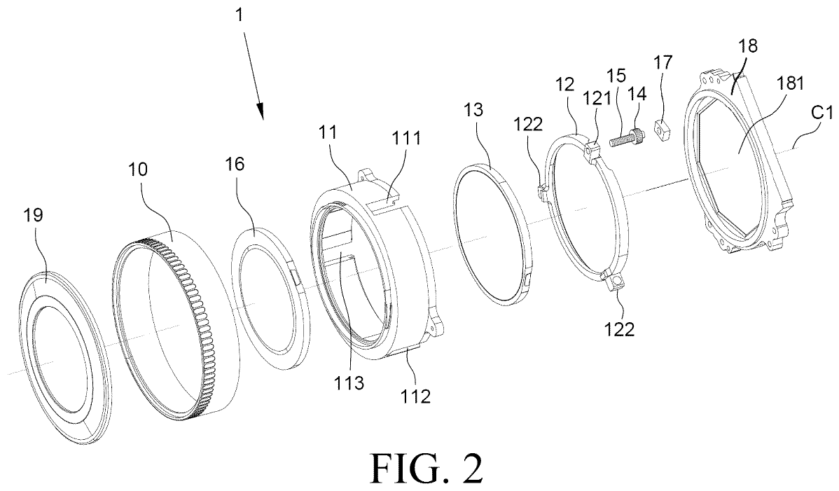

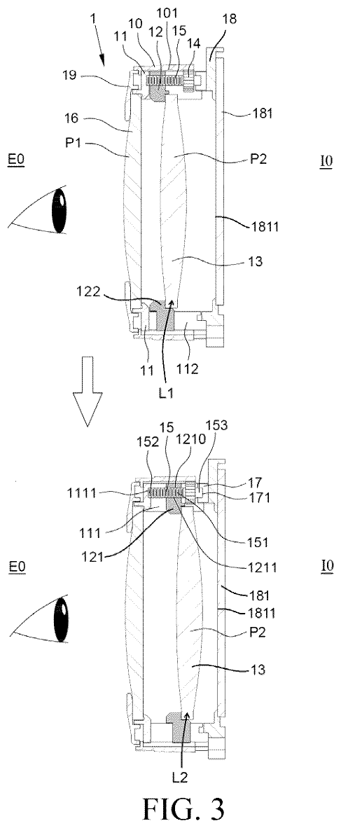

FIG. 1 is a combined three-dimensional schematic view of an optical focus adjustment module according to an embodiment of the present disclosure. FIG. 2 is an exploded three-dimensional schematic view of an optical focus adjustment module according to an embodiment of the present disclosure. FIG. 3 is a first combined sectional schematic view of an optical focus adjustment module according to an embodiment of the present disclosure, showing that a second optical lens assembly in a second lens barrel is moved from a first predetermined position to a second predetermined position. Referring to FIG. 3 and FIG. 2, the optical focus adjustment module 1 includes a central axis C1, an eye side E0 and an image source side I0 and further includes an operating ring 10, a first lens barrel 11, a first optical lens assembly 16, a second lens barrel 12, a second optical lens assembly 13, a gear 14 and a screw rod 15. The operating ring 10 includes an inner surface 101. The first lens barrel 11 is disposed in the operating ring 10 and includes three grooves 111, 112 and 113, and the three grooves 111, 112 and 113 are parallel to the central axis C1. The second lens barrel 12 is disposed in the first lens barrel 11 and includes one first protrusion portion 121 and two second protrusion portions 122. The first protrusion portion 121 includes a through hole 1210, and the through hole 1210 has an internally threaded structure 1211. The first protrusion portion 121 is disposed in one (such as the groove 111) of the three grooves 111, 112, 113, and is adapted to move parallel to the central axis C1. The two second protrusion portions 122 are disposed in the other two (such as the two grooves 112, 113) of the three grooves 111, 112, 113, and are adapted to move parallel to the central axis C1. The operating ring 10, the first lens barrel 11 and the second lens barrel 12 may be made of plastic materials.

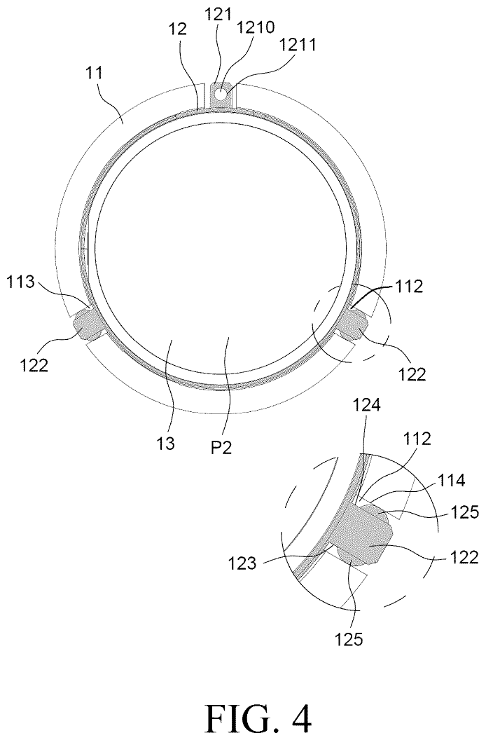

FIG. 4 is a combined sectional schematic view of a first lens barrel, a second lens barrel and a second optical lens assembly of an optical focus adjustment module according to an embodiment of the present disclosure. Each of the two second protrusion portions 122 is provided with a bump 125 located on a side surface 123, 124 of the corresponding second protrusion portion 122, and each of the bumps 125 is in contact with an inner wall 114 of the corresponding groove 112, 113. Each of the bumps 125 is in contact with the inner walls 114 of the corresponding grooves 112, 113, thereby reducing a friction force generated between the two second protrusion portions 122 and the grooves 112, 113 when the two second protrusion portions 122 move in the grooves 112, 113.

Referring to FIG. 3 again, each of the first optical lens assembly 16 and the second optical lens assembly 13 includes at least one optical lens. In the embodiment, the first optical lens assembly 16 is disposed in the first lens barrel 11 and includes a first optical lens P1. The second optical lens assembly 13 is disposed in the second lens barrel 12 and includes a second optical lens P2. The first optical lens P1 and the second optical lens P2 may be made of plastics or glass materials.

Referring to FIG. 3 again, the screw rod 15 is disposed in the through hole 1210 of the first protrusion portion 121 and includes a threaded structure 151, and the threaded structure 151 and the internally threaded structure 1211 of the through hole 121 are physically connected to each other (namely threaded connection). The screw rod 15 may be made of plastics or metal material. The threaded structure 151 of the screw rod 15 has a diameter M and a thread pitch P, and the following condition is satisfied: 1.5<M/P<10. For example, a front end 152 of the screw rod 15 is pivotally connected to a cavity 1111 in the corresponding groove 111 of the first lens barrel 11, a rear end 153 of the screw rod 15 is pivotally connected to a cavity 171 of a fixing block 17, the gear 14 is fixedly disposed on the screw rod 15 (for example, the gear 14 and the screw rod 15 are integrally formed and manufactured, but is not limited thereto), the gear 14 is meshed with the inner surface 101 of the operating ring 10, whereby the screw rod 15 can be rotationally synchronized with the gear 14 and the operating ring 10. In other words, after the operating ring 10 is rotated, the operating ring 10 can drive the internally threaded structure 1211 of the through hole 1210 of the first protrusion portion 121 of the second lens barrel 12 through the gear 14 and the threaded structure 151 of the screw rod 15, and further moves the second optical lens P2 of the second optical lens assembly 13 in the second lens barrel 12 to a predetermined position.

Referring to FIG. 3 again, the optical focus adjustment module 1 further includes an image source base 18 and an image source 181 (for example, a liquid crystal display, but is not limited thereto), the image source 181 is disposed in the image source base 18, and the image source base 181 located in the image source base 18 is disposed on the image source side I0 of the second lens barrel 13, wherein the operating ring 10 drives the second lens barrel 12 through the gear 14 and the screw rod 15, moves the second optical lens P2 of the second optical lens assembly 13 disposed in the second lens barrel 12 from a first predetermined position L1 to a second predetermined position L2 in a direction of the central axis C1, and further adjusts a distance between the second optical lens P2 of the second optical lens assembly 13 and the image source 181. In other words, an image distance of the optical focus adjustment module is adjusted. According to the optical focus adjustment module 1 of the present disclosure, it utilizes the interaction between the through hole 1210 of the first protrusion portion 121 of the second lens barrel 12 and the screw rod 15, and thus the distance between the second optical lens P2 of the second optical lens assembly 13 and the image source 181 can be adjusted only by rotating the operating ring 10 to drive the screw rod 15 to move, thereby achieving a myopia adjustment effect by adjusting image positions.

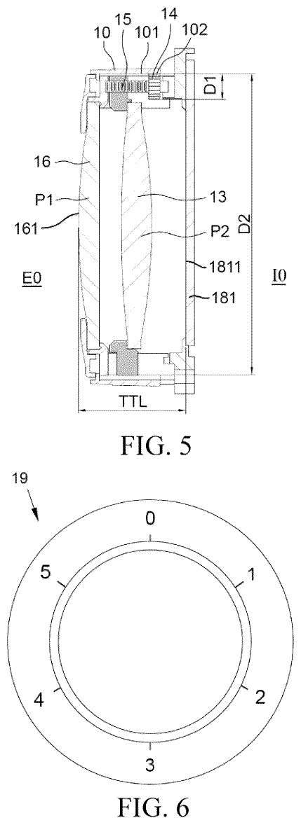

FIG. 5 is a second combined sectional schematic view of an optical focus adjustment module according to an embodiment of the present disclosure. Referring to FIG. 5, the gear 14 is disposed in the operating ring 10 and meshed with the inner surface 101 of the operating ring 10. The gear 14 may be made of plastics or metal material. In the embodiment, the operating ring 10 further includes an inner gear 102, and the inner gear 102 is disposed on the inner surface 101 of the operating ring 10, wherein a diameter of the gear 14 is D1, a tooth number of the gear 14 is n1, a diameter of the inner gear 102 is D2, a tooth number of the inner gear 102 is n2, a distance between an object-side surface 161 of the first optical lens P1 (namely, the optical lens being closest to the eye side E0) of the first optical lens assembly 16 and an image source surface 1811 of the image source 181 along the central axis C1 is TTL, and the following condition is satisfied: 3.1<((D2/D1)*(n2/n1)/TTL<5.3.

FIG. 6 is a plan view of a scale cover of an optical focus adjustment module according to an embodiment of the present disclosure. Referring to FIG. 6 and FIG. 3, the optical focus adjustment module 1 further includes the scale cover 19 which is disposed outside the first lens barrel 11 and shows operating scales capable of compensating for myopia, such as 0, 1, 2, 3, 4 and 5 representing different image distances, i.e., six predetermined positions of the second optical lens P2 of the second optical lens assembly 13 (for example, FIG. 3 already shows the first predetermined position L1 and the second predetermined position L2 of the second optical lens P2 of the second optical lens assembly 13), but is not limited thereto, whereby a myopia user can rapidly operate and use the optical focus adjustment module 1. The present disclosure can compensate the myopia degree by at least two image distances, so as to compensate the myopia degree.

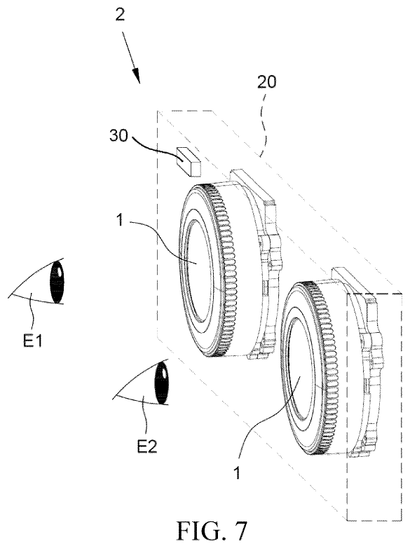

FIG. 7 is a three-dimensional schematic view of a head mounted electronic device according to an embodiment of the present disclosure. The head mounted electronic device 2 includes a shell 20, at least one optical focus adjustment modules 1 of the present disclosure, and a controller 30. The optical focus adjustment module 1 is disposed in the shell 20. The controller 30 is disposed in the shell 20 and electrically connected to the optical focus adjustment module 1. The controller 30 may be a general Processor, a Micro Control Unit (MCU), an Application Processor (AP), a Digital Signal Processor (DSP), a Graphics Processing Unit (GPU) or a Holographic Processing Unit (HPU), or any combination of the above processors, and may include various circuit logics for providing a processing and operation function of data and image and transmitting frame data (such as data for representing character messages, graphs or images) to the image source (such as LCD) of each optical focus adjustment module 1. In this embodiment, the head mounted electronic device 2 includes two of the optical focus adjustment modules 1 respectively corresponding to a left eye E1 and a right eye E2 so that an imaging distance between the image source 181 and the left eye E1 or the right eye E2 can be independently adjusted, and namely the left eye E1 or the right eye E2 can independently compensate proper myopia degree.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. An optical focus adjustment module having a central axis, an eye side and an image source side, the optical focus adjustment module comprising:
an operating ring comprising an inner surface;
a first lens barrel disposed in the operating ring and comprising three grooves parallel to the central axis;
a first optical lens assembly disposed in the first lens barrel;
a second lens barrel disposed in the first lens barrel and comprising one first protrusion portion and two second protrusion portions, wherein:
the first protrusion portion comprises a through hole having an internally threaded structure, and the first protrusion portion is disposed in one of the three grooves, and adapted to move parallel to the central axis; and
the two second protrusion portions are disposed in the other two of the three grooves, and adapted to move parallel to the central axis;
a second optical lens assembly disposed in the second lens barrel;
a gear disposed in the operating ring and meshed with the inner surface of the operating ring; and
a screw rod disposed in the through hole and comprising a threaded structure, wherein the threaded structure and the internally threaded structure are physically connected to each other, and the screw rod is rotationally synchronized with the gear and the operating ring.

2. The optical focus adjustment module according to claim 1, wherein each of the two second protrusion portions is provided with a bump located on a side surface of the corresponding second protrusion portion, and each of the bumps is in contact with an inner wall of the corresponding groove.

3. The optical focus adjustment module according to claim 2, wherein each of the bumps is in contact with the inner walls of the corresponding grooves.

4. The optical focus adjustment module according to claim 2, wherein the bumps are in contact with the inner walls of the corresponding grooves in a point-contact manner.

5. The optical focus adjustment module according to claim 1, wherein each of the first optical lens assembly and the second optical lens assembly comprises at least one optical lens.

6. The optical focus adjustment module according to claim 1, further comprising an image source disposed on the image source side of the second lens barrel, wherein the operating ring further comprises an inner gear disposed on the inner surface of the operating ring, a diameter of the gear is D1, a tooth number of the gear is n1, a diameter of the inner gear is D2, a tooth number of the inner gear is n2, a distance between an object-side surface of one optical lens, being closest to the eye side, of the first optical lens assembly and an image source surface of the image source along the central axis is TTL, and the following condition is satisfied: 3.1<((D2/D1)*(n2/n1)/TTL<5.3.

7. The optical focus adjustment module according to claim 1, wherein the threaded structure of the screw rod has a diameter M and a pitch P, and the following condition is satisfied: 1.5<M/P<10.

8. The optical focus adjustment module according to claim 1, further comprising an image source disposed on the image source side of the second lens barrel, wherein the operating ring drives the second lens barrel through the gear and the screw rod, moves the second optical lens assembly in the second lens barrel from a first predetermined position to a second predetermined position in a direction of the central axis, and further adjusts a distance between the second optical lens assembly and the image source.

9. A head mounted electronic device, comprising:
a shell;
at least one optical focus adjustment module disposed in the shell, wherein:
the optical focus adjustment modules having a central axis, an eye side and an image source side, the optical focus adjustment module comprising:
an operating ring comprising an inner surface;
a first lens barrel disposed in the operating ring and comprising three grooves parallel to the central axis;
a first optical lens assembly disposed in the first lens barrel;
a second lens barrel disposed in the first lens barrel and comprising one first protrusion portion and two second protrusion portions, wherein:
the first protrusion portion comprises a through hole having an internally threaded structure, and the first protrusion portion is disposed in one of the three grooves and adapted to move parallel to the central axis; and
the two second protrusion portions are disposed in the other two of the three grooves and adapted to move parallel to the central axis;
a second optical lens assembly disposed in the second lens barrel;
a gear disposed in the operating ring and meshed with the inner surface of the operating ring; and
a screw rod disposed in the through hole and comprising a threaded structure, wherein the threaded structure and the internally threaded structure are physically connected to each other, and the screw rod is rotationally synchronized with the gear and the operating ring; and
a controller disposed in the shell.

10. The head mounted electronic device according to claim 9, comprising two of the optical focus adjustment modules respectively corresponding to a left eye and a right eye.

11. The head mounted electronic device according to claim 9, wherein each of the two second protrusion portions is provided with a bump on a side surface of the corresponding second protrusion portion, and each of the bumps is in contact with an inner wall of the corresponding groove.

12. The head mounted electronic device according to claim 11, wherein each of the bumps is in contact with the inner walls of the corresponding grooves.

13. The head mounted electronic device according to claim 11, wherein the bumps are in contact with the inner walls of the corresponding grooves in a point-contact manner.

14. The head mounted electronic device according to claim 9, wherein each of the first optical lens assembly and the second optical lens assembly comprises at least one optical lens.

15. The head mounted electronic device according to claim 9, further comprising an image source disposed on the image source side of the second lens barrel, wherein the operating ring further comprises an inner gear disposed on the inner surface of the operating ring, a diameter of the gear is D1, a tooth number of the gear is n1, a diameter of the inner gear is D2, a tooth number of the inner gear is n2, a distance between an object-side surface of one optical lens, closest to the eye side, of the first optical lens assembly and an image source surface of the image source on the central axis is TTL, and the following condition is satisfied: 3.1<((D2/D1)*(n2/n1)/TTL<5.3.

16. The head mounted electronic device according to claim 9, wherein the threaded structure of the screw rod has a diameter M and a pitch P, and the following condition is satisfied: 1.5<M/P<10.

17. The head mounted electronic device according to claim 9, further comprising an image source disposed on the image source side of the second lens barrel, wherein the operating ring drives the second lens barrel through the gear and the screw rod, moves the second optical lens assembly in the second lens barrel from a first predetermined position to a second predetermined position in a direction of the central axis, and further adjusts a distance between the second optical lens assembly and the image source.
